(19) United States
(12) Patent Application Publication
(10) Pub. No.: US 2006/0015377 A1
(43) Pub. Date: Jan. 19, 2006

(54) Method and system for detecting business behavioral patterns related to a business entity

(75) Inventors: Bethany Kniffin Hoogs, Niskayuna, NY (US); Deniz Senturk, Niskayuna, NY (US); Christina Ann LaComb, Schenectady, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/890,836

(22) Filed: Jul. 14, 2004

(51) Int. Cl. G06F 9/44

(52) U.S. Cl. 705/7

(57) ABSTRACT

A method and system for detecting business behavioral patterns related to a business entity is provided. The method comprises determining a model for business behavioral patterns in which the likelihood of a particular business behavioral pattern is associated with the occurrence of a qualitative event and a quantitative metric. The method further comprises extracting a first data set from a first data source and a second data set from a second data source. The first data set represents the occurrence of the qualitative event associated with the business entity. The second data set represents the quantitative metric associated with the business entity. Then a first confidence attribute and a first temporal attribute associated with the qualitative event is determined. Similarly, a second confidence attribute and a second temporal attribute associated with the quantitative metric are determined. Finally, the likelihood of the particular business behavior pattern is evaluated by running the model based on the first data set, the second data set, the first confidence attribute, the first temporal attribute, the second confidence attribute and the second temporal attribute.

### BACKGROUND OF THE INVENTION

The invention relates generally to monitoring the financial health of a business entity and more specifically to a method and system for inferring business risk information and detecting business behavioral patterns related to a business entity.

There are several commercially available tools that permit financial analysts to infer business risk information related to a business entity by analyzing many of the publicly available sources of financial information. These tools typically take into account quantitative financial information to generate risk scores indicative of the financial health of the business entity. Quantitative financial information may include, for example, financial statement reports, stock price, volume and credit and debt ratings related to the business entity. These tools typically do not take into account other forms of information such as business event data related to the business entity that may arise between financial statement reports and may materially affect the assessed health of the business entity. In addition, these tools generate risk scores with an assumption that the financial statement used to generate the score is accurate.

In order to account for the disadvantages associated with the above commercial tools, financial analysts typically monitor qualitative business event information of a business entity through the use of forensic accounting techniques. Qualitative information may include, for example, business event data that reflect certain behavioral symptoms or catalysts of financial stress associated with the business entity such as executive staff changes or accountant changes. However, a disadvantage with qualitative data techniques is the manual collection and assimilation of vast amounts of information. Also the collection of such vast amounts of information is not standardized, not subject to the rigor of statistical analysis, and is not a scalable technique.

Therefore, there is a need for a system and method for systematically integrating both qualitative and quantitative financial information to infer business risk information and determine business behavioral patterns related to a business entity.

### BRIEF DESCRIPTION OF THE INVENTION

In one embodiment of the invention, a method for detecting business behavioral patterns related to a business entity is provided. The method comprises determining a model for business behavioral patterns in which the likelihood of a particular business behavioral pattern is associated with the occurrence of a qualitative event and a quantitative metric. The method further comprises extracting a first data set from a first data source and a second data set from a second data source. The first data set represents the occurrence of the qualitative event associated with the business entity. The second data set represents the quantitative metric associated with the business entity. Then a first confidence attribute and a first temporal attribute associated with the qualitative event are determined. Similarly, a second confidence attribute and a second temporal attribute associated with the quantitative metric is determined. Finally, the likelihood of the particular business behavior pattern is evaluated by running the model based on the first data set, the second data set, the first confidence attribute, the first temporal attribute, the second confidence attribute and the second temporal attribute.

In a second embodiment, a method for detecting business behavioral patterns related to a business entity is provided. The method comprises formulating a risk assessment model related to the business entity and expressing the risk assessment model as a probabilistic network with node elements. The node elements comprise quantitative data and qualitative data. The method further comprises determining a temporal attribute and a confidence attribute associated with the qualitative data and the quantitative data and populating the node elements with the temporal attribute and confidence attribute. Then, the method comprises inferring one or more risk probability values for one or more higher level node elements in the probabilistic network based on the qualitative data and quantitative data in the node elements and their temporal and confidence attributes. Finally, the method comprises detecting the business behavioral patterns related to the business entity based on the one or more inferred risk probability values.

In a third embodiment, a system for detecting business behavioral patterns related to a business entity is provided. The system comprises a data extraction engine configured to extract a first data set representing the occurrence of a qualitative event associated with the business entity from a first data source and a second data set representing a quantitative metric associated with the business entity from a second data source. The system further comprises a data modeling engine configured to determine business behavioral patterns in which the likelihood of a particular business behavioral pattern is associated with the occurrence of the qualitative event and the quantitative metric. The data modeling engine is further configured to determine a first confidence attribute and a first temporal attribute associated with the qualitative event and a second confidence attribute and a second temporal attribute associated with the quantitative metric. Then, the data modeling engine evaluates the likelihood of the particular business behavior pattern based on the first data set, the second data set, the first confidence attribute, the first temporal attribute, the second confidence attribute and the second temporal attribute.

### BRIEF DESCRIPTION OF THE DRAWINGS

FIG. 1 shows a schematic of a general-purpose computer system in which one embodiment of a system for detecting business behavioral patterns related to a business entity may operate;

FIG. 2 is an illustration of a high-level component architecture diagram of one embodiment of a system for detecting business behavioral patterns related to the business entity that can operate on the computer system of FIG. 1;

FIG. 3 is a flowchart describing exemplary steps for detecting business behavioral patterns using the risk assessment model depicted in FIG. 2, in accordance with one embodiment of the invention;

FIG. 4 is an exemplary heuristic depicted using the risk assessment model;

FIG. 5 is an exemplary interaction of one or more temporal relationships between qualitative data and quantitative data represented in the heuristic depicted in FIG. 4;

FIG. 6 is an illustration of a normal distribution that represents an unordered proximity type of temporal relationship;

FIG. 7 is an illustration of a negatively skewed distribution that represents an unordered proximity type of temporal relationship;

FIG. 8 is an illustration of a distribution that represents a preceding proximity type of temporal relationship;

FIG. 9 is an illustration of a discrete table of weights for temporal ranges; and

FIG. 10 is an exemplary heuristic depicted using a Bayesian belief network.

### DETAILED DESCRIPTION OF THE INVENTION

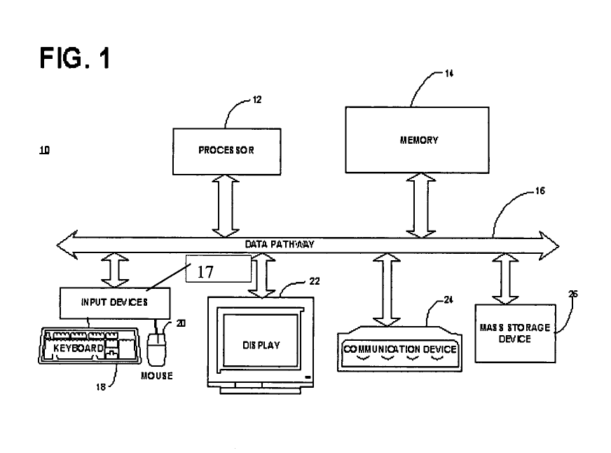

FIG. 1 shows a schematic of a general-purpose computer system 10 in which one embodiment of a system for detecting business behavioral patterns related to a business entity may operate. The computer system 10 generally comprises at least one processor 12, a memory 14, input/output devices 17, and data pathways (e.g., buses) 16 connecting the processor, memory and input/output devices.

The processor 12 accepts instructions and data from the memory 14 and performs various data processing functions of the system 10 such as extracting qualitative events and quantitative metrics related to a business entity from business and financial information sources and evaluating the likelihood of a particular business pattern from the qualitative events and the quantitative metrics. The processor 12 includes an arithmetic logic unit (ALU) that performs arithmetic and logical operations and a control unit that extracts instructions from memory 14 and decodes and executes them, calling on the ALU when necessary. The memory 14 stores a variety of data computed by the various data processing functions of the system 10. The data may include, for example, quantitative financial data such as financial measures and ratios or commercially available financial rating scores, qualitative business event information and business behavioral patterns related to the financial health of the business entity. The memory 14 generally includes a random-access memory (RAM) and a read-only memory (ROM); however, there may be other types of memory such as programmable read-only memory (PROM), erasable programmable read-only memory (EPROM) and electrically erasable programmable read-only memory (EEPROM). Also, the memory 14 preferably contains an operating system, which executes on the processor 12. The operating system performs basic tasks that include recognizing input, sending output to output devices, keeping track of files and directories and controlling various peripheral devices. The information in the memory 14 might be conveyed to a human user through the input/output devices 17, data pathways (e.g., buses) 16, or in some other suitable manner.

The input/output devices 17 may further comprise a keyboard 18 and a mouse 20 that a user can use to enter data and instructions into the computer system 10. Also, a display 22 may be included to allow a user to see what the computer has accomplished. Other output devices may include a printer, plotter, synthesizer and speakers. A communication device 24 such as a telephone, cable or wireless modem or a network card such as an Ethernet adapter, local area network (LAN) adapter, integrated services digital network (ISDN) adapter, or Digital Subscriber Line (DSL) adapter, enables the computer system 10 to access other computers and resources on a network such as a LAN or a wide area network (WAN). A mass storage device 26 may be used to allow the computer system 10 to permanently retain large amounts of data. The mass storage device may include all types of disk drives such as floppy disks, hard disks and optical disks, as well as tape drives that can read and write data onto a tape, for example, a digital audio tape (DAT), digital linear tape (DLT), or other magnetically coded media. The above-described computer system 10 can take the form of a hand-held digital computer, personal digital assistant computer, notebook computer, personal computer, workstation, mini-computer, mainframe computer or supercomputer.

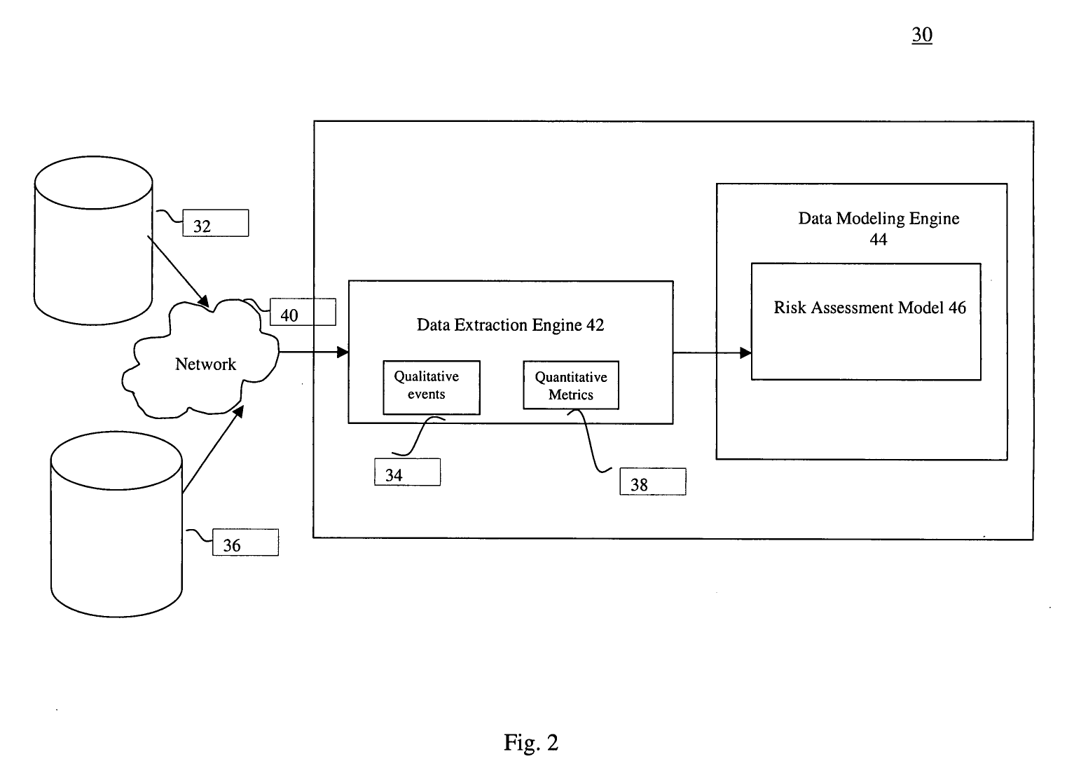

FIG. 2 is an illustration of a high-level component architecture diagram 30 of one embodiment of a system for detecting business behavioral patterns related to the business entity that can operate on the computer system 10 of FIG. 1. In the illustrated embodiment, the system 30 comprises a first data source 32 and a second data source 36. The system 30 further comprises a data extraction engine 42 and a data modeling engine 44. The data modeling engine 44 further comprises a risk assessment model 46. One of ordinary skill in the art will recognize that the system 30 is not necessarily limited to these elements. It is possible that the system 30 may have additional elements or fewer elements than what is indicated in FIG. 2.

Further details of architectures of systems for detecting business behavioral patterns can be found in co-pending U.S. patent application Ser. No. 10/719,953 entitled “SYSTEM, METHOD AND COMPUTER PRODUCT TO DETECT BEHAVIOR PATTERNS RELATED TO THE FINANCIAL HEALTH OF A BUSINESS ENTITY”, filed on 21 Nov. 2003 and assigned to the same assignee as this application, the entirety of which is hereby incorporated by reference herein.

As shown in FIG. 2, the data extraction engine 42 extracts a first data set representing the occurrence of a qualitative event 34 associated with the business entity from the first data source 32 and a second data set representing a quantitative metric 38 associated with the business entity from the second data source 36. In accordance with the present embodiment, the first data source 32 generally comprises on-line news sources, commercial news sources such as WALL STREET JOURNAL, BLOOMBERG, etc, business trade and industry publications, news reports, footnotes to financial statements, and qualitative financial data learned in interviews and discussions with the business entity. The second data source 36 generally comprises financial results and internal financial statements related to the business entity, stock exchange reports and quantitative risk scores produced by commercial databases such as Moody's KMV, Standard & Poor ratings and Dun and Bradstreet's PAYDEX®.

The qualitative event 34 typically comprises verbal or narrative pieces of data representative of one or more business and financial occurrences associated with the business entity. Business and financial occurrences may include, for example, change of auditors, management changes, change of accounting methods, litigation, events related to defaults on credit or loan agreements, bankruptcy rumors, bankruptcy, debt restructure, loss of credit, investigations by the Security Exchange Commission (SEC), restatement of previously published earnings, layoffs, wage reductions, company restructures, refocused objectives, mergers and acquisitions, regulatory changes and industry events that may impact a business entity.

The quantitative metric 38 typically includes numerical data related to the financial health of the business entity. Numerical data, may include, for example, financial statement data, accounts payable, accounts receivable, notes receivable, cash and cash equivalents, depreciation, deferred revenue, inventory, fixed assets, debt, total assets, total current assets, total current liabilities, total equity, total liabilities, cash flow from financing, cash flow from investing, cash flow from operations, operating expenses, other income, other expenses, operating income, interest expense, cost of goods sold, extraordinary items, net income, total revenue, net intangibles, goodwill, non-recurring items, acquisitions, restructuring charges, in-process research and development, capital expenditures, reserves, bad debt, unbilled receivables, payment history, stock price and volume, credit and debt ratings, industry performance averages and commercially available risk scores.

Referring again to FIG. 2, the data extraction engine 42 extracts the qualitative events 34 and the quantitative metrics 38 from the first data source 32 and the second data source 36 through a network 40. The network 40 is typically a communication network such as an electronic or wireless network that connects the system 30 to the data sources. The network may comprise any one of several suitable forms known to those in the art, including, for example, a private network such as an extranet or intranet or a global network such as a WAN (e.g., Internet). Further, it is not necessary that the data extraction engine 42 extract the qualitative events and the quantitative metrics from a network. The qualitative events and the quantitative metrics may be manually extracted and provided on weekly CDs, for example. The data extraction engine may further perform some preliminary analysis on the extracted quantitative metrics by analyzing the quantitative metrics with respect to one or more past quantitative metrics related to the business entity or current or past quantitative metrics related to one or more industrial segments associated with the business entity. Further details of quantitative data analysis for detecting business behavioral patterns related to a business entity may be found in co-pending U.S. patent application Ser. No. 10/719,953 entitled “SYSTEM, METHOD AND COMPUTER PRODUCT TO DETECT BEHAVIOR PATTERNS RELATED TO THE FINANCIAL HEALTH OF A BUSINESS ENTITY”, filed on 21 Nov. 2003 and assigned to the same assignee as this application, the entirety of which is hereby incorporated by reference herein.

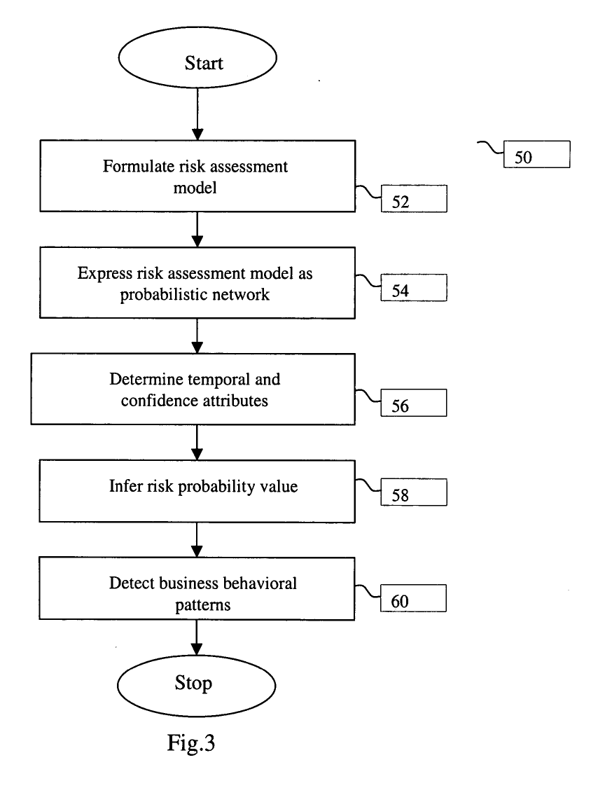

The system 30 for detecting behavioral patterns further comprises a data modeling engine 44. In accordance with one embodiment, the data modeling engine 44 is configured to determine a model for business behavioral patterns related to the business entity, wherein the likelihood of a particular business behavioral pattern is associated with the occurrence of the qualitative event 34 and the quantitative metric 38. In particular, the data modeling engine uses a risk assessment model 46 to infer business risk information and further evaluate the likelihood of a particular business behavioral pattern related to the business entity based on the inferred business risk information. As used herein, “business behavioral patterns” comprise likelihood of fraud, financial credit or investment risk and good credit or investment prospect associated with the business entity. FIG. 3 is a flowchart describing in greater detail, exemplary steps for detecting business behavioral patterns using the risk assessment model 46 shown in FIG. 2.

FIG. 3 is a flowchart 50 describing exemplary steps for detecting business behavioral patterns using the risk assessment model depicted in FIG. 2, in accordance with one embodiment of the invention. In step 52, a risk assessment model is formulated. In step 54, the risk assessment model is expressed as a probabilistic network with node elements. In accordance with the present embodiment, the node elements comprise quantitative data and qualitative data. The quantitative data generally represents quantitative metrics and the qualitative data generally represents qualitative events related to the business entity.

In step 56, temporal attributes and confidence attributes associated with the qualitative data and quantitative data are determined and the node elements are populated with these attributes in addition to the qualitative data and the quantitative data. In accordance with the present embodiment, the temporal attribute is represented by a date or time of occurrence of a particular qualitative or quantitative data event. For example, temporal attributes associated with quantitative data may include specific dates on which financial results are reported (such as, every quarterly or yearly period), stock prices and volume reports at a given point in time, or averaged over a defined period of time, or financial ratings tracked by time. Similarly, temporal attributes associated with qualitative data may include news reports or financial footnotes generated on particular dates. Some other qualitative facts, such as the industry in which a business operates, may have no specific date, but can still be represented temporally with an open-ended duration, indicating that the data assertion is always true.

In accordance with the present embodiment, one or more temporal relationships between the qualitative and quantitative data events are derived from the temporal attributes. The temporal relationships are further used to infer business risk information as will be described in greater detail below. In accordance with the present embodiment, the temporal attribute is a representation of the time at which a qualitative or quantitative data event occurred and possibly a duration for which the data event or state remained in effect. The temporal relationship is represented as a weight that is derived from the temporal attributes of two qualitative and/or quantitative data. The weight reflects the impact of the temporal proximity and/or order of the two types of data to the inferred business risk. In particular, the temporal relationship may be used to adjust the business risk information based on the temporal proximity and/or order of the evidence or information provided by the qualitative or quantitative data. The temporal relationship weight may be represented either continuously as distributions or discretely in tables as will be described in greater detail below. Types of distributions may include, normal distributions, half normal distributions, step functions or exponential distributions. In a typical temporal relationship distribution, the highest weight is assigned when the temporal distance between any two events is zero, (that is, the events occur simultaneously), indicated by a zero mean value of the distribution, and the weight decreases as the amount of time between the two events increases

In addition to the temporal attribute, the quantitative data and the qualitative data also have an associated confidence attribute. In accordance with a particular embodiment of the invention, the confidence attribute is a reflection of a degree of certainty in the information extracted from the data sources. In particular, the confidence attribute may be used to adjust the business risk information based on the evidence or information provided by the qualitative or quantitative data as described in greater detail below. In accordance with the present embodiment, the confidence attribute is represented as a weight. A singular weight may be defined for all possible states or conditions for a given qualitative or quantitative node, or one or more weights may be associated with a given qualitative or quantitative node. Furthermore, the weights may be expressed continuously as distributions, or discretely in tables.

For qualitative data, the confidence attribute weight is determined based on heuristics such as a reliability value of one or more data sources associated with the qualitative data, and is generally discrete. The confidence attribute may also be based on other heuristics such as the confidence of the interpretation of the data source associated with the qualitative data. For quantitative data, the confidence attribute is based on a statistical confidence range associated with the quantitative data, and is typically continuous. The confidence weights are then applied to infer the business risk information as will be described in greater detail below.

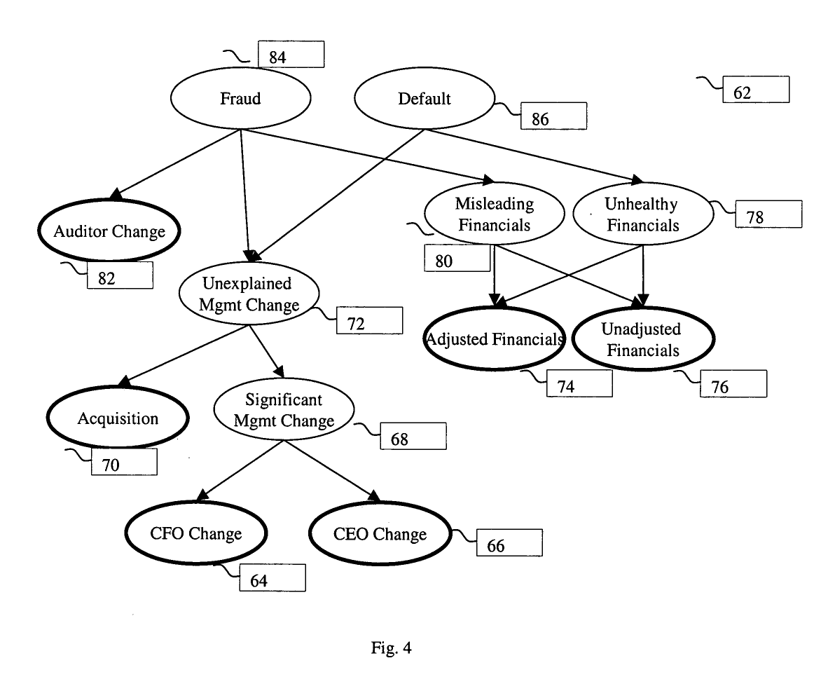

By representing confidence attributes as a weight and incorporating that weight into the determination of business risk information, the risk assessment model of the invention combines derived confidence attributes, both heuristically as well as statistically to accurately reflect a combined confidence weight in the inference of the risk probability values. In addition, the risk assessment model may also use the confidence attributes to fine-tune the reasoning logic that is applied to the qualitative data and the quantitative data, by traversing only those paths in the probabilistic network 62 for which the supporting data has sufficiently high confidence weights. For example, in the heuristic shown in FIG. 4, a strong confidence weight associated with the occurrence of the “CFO change” and “CEO change” events trigger the likelihood of occurrence of a “significant management change” event. In such a case, the reasoning logic may be fine tuned to further analyze the paths in the probabilistic network that possess high confidence weights (that is, that have a high likelihood of the occurrence of a business behavioral pattern) by traversing only those paths in the probabilistic network for which the supporting data in one or more higher level nodes has sufficiently high confidence weights. This enables the risk assessment model to perform focused investigation of business risk information and business behavioral patterns related to the business entity.

In step 58, one or more risk probability values for one or more high level node elements comprising the probabilistic network are inferred based on the qualitative data, the quantitative data, the temporal attribute and the confidence attribute. As used herein, the risk probability values refer to business risk information associated with the business entity. As will be described in greater detail in FIG. 4, the quantitative data and the qualitative data in the node elements in relation with the confidence attribute and temporal attribute serve as contributing sources of evidence for the high level node elements to infer the risk probability values in the probabilistic network.

In step 60, the business behavioral patterns associated with the business entity are detected based on the risk probability values. In particular, the risk assessment model detects the business behavioral patterns using a fusion reasoning methodology. The fusion reasoning methodology analyzes the node elements comprising the quantitative data and the qualitative data in relation to the temporal attribute and the confidence attribute to detect the business behavioral patterns related to the business entity. The fusion reasoning methodology is described in greater detail in FIG. 4.

FIG. 4 is an exemplary heuristic depicted using the risk assessment model. The heuristic is represented as a probabilistic network 62 comprising node elements connected by probability functions. In accordance with the present embodiment, the probability functions mathematically incorporate the temporal and confidence attributes to infer the risk probability values as will be described in greater detail below.

Referring to FIG. 4, the leaf nodes, such as, for example, 64 and 66 represent quantitative and qualitative data that may be observed or calculated from the data sources 32 and 36 as shown in FIG. 2. The high-level node elements comprising the probabilistic network 62, such as, for example, 72 and 84 represent one or more inference nodes. In accordance with the present embodiment, the quantitative data and the qualitative data in the leaf nodes in relation with their associated confidence attributes and temporal attributes serve as contributing sources of evidence for the high level node elements to infer the risk probability values in the probabilistic network. Therefore, the risk probability value of an inferred node is a function of the qualitative and quantitative data items comprising the evidence for that node, the confidence in the data items represented by the confidence attribute, and the temporal relationship between the data items. In particular, each evidence node contributes belief to the inferred node. In the fusion reasoning methodology described in greater detail below, the belief contributed by observation of evidence, recorded as a change in state of an evidence node, is adjusted by the confidence of the evidence, and the combined belief contributed by two or more evidence nodes is adjusted by the temporal relationships between the evidence nodes.

The inferred risk probability of the occurrence of a “significant management change” event 68, for example, is a function of a “CFO change”, represented by the leaf node 64, a “CEO change”, represented by the leaf node 66, the confidence in the “CFO change” event 64, and the “CEO change” event 66, and the temporal proximity of the two events 64 and 66. The inferred risk probability for the “significant management change” event 68 is then computed by the probability function:
P(SMC)=ƒ(CEO′, CFO′, TR_{cfo-ceo}) (1)
wherein CEO′ is the observation of the “CEO change” event 66 adjusted by the confidence of the occurrence of the event, CFO′ is the observation of the “CFO change” event 64 adjusted by confidence of the occurrence of the event, and TR_{cfo-ceo} is the temporal relationship between the two events 64 and 66. The observations adjusted by their confidence are expressed as weights in this function, with values between 0 and 1, where 1 represents certainty of a positive observation of the event, and 0 represents certainty of the negative observation of the event. The temporal relationships are also expressed as weights in this function, with values between 0 and 1, where 1 represents the most significant temporal relationship, and values approach 0 as the significance of the temporal relationship decreases. In one implementation of this example, the function to derive the probability of the inferred node is as follows:
P(SMC)=((CEO′+CFO′)*TR_{cfo-ceo})/2 (2)

If both events have been observed, with a confidence weight value of 0.8, based on a heuristic regarding the source(s) of the data, and the temporal relationship weight is 0.9, based on the distribution mapping the time lag between these two events to weights, then the probability of the inferred node will be ((0.8+0.8)*0.9)/2=0.72.

If only one of the events has a positive observation, again with a 0.8 confidence weight value, then we use the lower bound of the temporal relationship weights for the timeframe of interest between the two events as the temporal relationship weight in the function. For example, if the temporal relationship between the CEO leaving event and CFO leaving event becomes insignificant at the end of 2 years, and the temporal relationship weight for these events at two years is 0.4, then that value is used in the-function to yield ((0+0.8)*0.4)/2=0.16. This example assumes that the lack of observation results in certainty of a negative observation for the other event (such as observing no news of a CEO change for a large, well known corporation). Alternatively, a heuristic relating the lack of observation to a probability that it occurred, even though unobserved, could be used. If both observations are negative, the inferred probability becomes 0, as the numerator of the function results in 0. This is one example of a probabilistic function that can be used to calculate the likelihood of an inferred node, but probabilistic functions of other forms can also be used.

The risk assessment model further uses a fusion reasoning methodology to evaluate the quantitative data in combination and relation to the qualitative data to substantiate, explain or repudiate the inferred risk probability values seen in the quantitative data or the qualitative data. As used herein “substantiation” occurs when two or more evidence nodes combine to increase the probability of the inferred risk, “explanation” occurs when additional evidence nodes decrease the probability of the inferred risk, and “repudiation” occurs when additional evidence nodes cause the assertion of a different state for the inferred risk probability. The following paragraphs describe some examples of the use of the fusion reasoning methodology to infer business risk information related to a business entity.

The fusion reasoning methodology may be used to “explain” the quantitative data results based on qualitative event data. For example, a quantitative comparison of inventory reported on a balance sheet over time may show a sudden increase. This may be a cause for concern if it indicates a reduction in demand for the business' product. However, if qualitative data in the financial statement footnotes indicates that the business has changed their method of inventory valuation in the same period as the increase, the increase is not of immediate concern. In this case, the qualitative data obtained, and its simultaneous temporal relationship to the inventory increase provides a reasonable “explanation” for the increase. Alternatively, if the inventory valuation method change occurs after the inventory increase, (that is, the two events occurred at different time periods), the confidence that the valuation method change “explains” the inventory increase is reduced.

As another example, the fusion reasoning methodology may be used to “substantiate” quantitative data results with qualitative data. For example, a result of a quantitative financial analysis of the financial debt associated with a business entity may indicate that it is significantly higher than the financial debt exhibited by one or more industrial segments associated with the business entity. If the qualitative data related to the business entity also indicated that large off-balance-sheet financial debt existed at the same time, then the qualitative data “substantiates” the concern that the business entity is carrying a financial risk of debt. In this case, the simultaneous temporal relationship between the qualitative and quantitative data is important to determine the financial risk. If, however, the two types of debt existed at different (or non-overlapping) time periods, the debt is of less significant concern. In another example, if qualitative data related to a business entity indicates the introduction of a new competing technology for a business, and subsequent financial statements show a sharp decline in sales, the quantitative data analysis “substantiates” the concern over the impact of the technology introduction event to the financial health of the business. If, however, a sales decline is detected before the competing technology is announced, then the probability of risk will be different, and may in fact be higher because the business entity is already exhibiting a symptom of declining health before the occurrence of any event that may worsen it.

The fusion reasoning methodology may be used to “repudiate” quantitative data based on qualitative data. For example, if quantitative data analysis determines that a company shows a positive outlook in pro-forma financial statements, and, in the same timeframe, qualitative data is discovered that indicates that the CEO is selling large amounts of company stock, the qualitative data “repudiates” the positive outlook. If the belief, contributed by the stock dumping evidence, that the inferred risk is high, is greater than the belief, contributed by the pro-forma statement evidence, that the inferred risk is low, the fusion reasoning methodology analyzes that the business entity has a higher level of business risk than indicated by the pro-forma results. In general, although stock dumping may always generate a measure of doubt about the financial health of a business entity, the temporal proximity to the positive pro-forma results in this example generates an impression that the pro-forma results are misleading.

Referring again to the heuristic depicted in FIG. 4, the “fraud” node 84 is comprised of three substantiating evidence nodes, “unexplained management change” 72, “auditor change” 82 and “misleading financials” 80. A positive observation for each of the evidence nodes, 72, 80 and 82 increases the inferred risk probability for fraud. Similarly, the “unexplained management change” node 72 comprises two evidence nodes, “acquisition” 70 and “significant management change” 68. In this case, a positive observation of an “acquisition” 70 provides an explanation for a positive observation of a “significant management change” 68, and decreases the risk probability for the inferred node, “unexplained management change” 72. As another example, the “unhealthy financials” node 78, comprises two evidence nodes, “adjusted financials” 74, and “unadjusted financials” 76. In this case, a negative state for the “unhealthy financials” node 78 may be based on a positive state for the “unadjusted financials” node 76 (that is, the financials look good so the reasoning asserts good financial health), but can be countered by an observation of a negative state for the “adjusted financials” node 74 (that is, once adjusted for unusually large write-offs, the financials no longer look good so the reasoning asserts poor financial health). In this example, when good unadjusted financials and poor adjusted financials are observed, the fusion reasoning methodology switches the state of the inferred unhealthy financials node to positive, whereas based solely on good unadjusted financials, the inferred state for unhealthy financials would have been negative. Thus the observation of poor adjusted financials repudiates the assertion that would be made on good unadjusted financials alone.

As is apparent from the above discussion, the inclusion of temporal relationships and confidence attributes of data items is significant in the fusion of quantitative and qualitative analysis of business risk information. In addition, temporal information has a significant impact on the weight that the fusion reasoning methodology should give to the qualitative and quantitative data. For example, a CEO resignation in 1986 probably has little or no bearing on a change in auditors occurring in 2003. However, if the two events occurred within a few months of each other, the combination of the two events and their temporal proximity may be an indicator of questionable accounting. Similarly, as discussed above, confidence in individual data items also impacts the weight assigned to the qualitative and quantitative data. For example, if qualitative data, such as a report that off-balance-sheet debt exists, came from an unreliable data source, then that data should be given a low confidence which should in turn be reflected in any assertions based on that data.

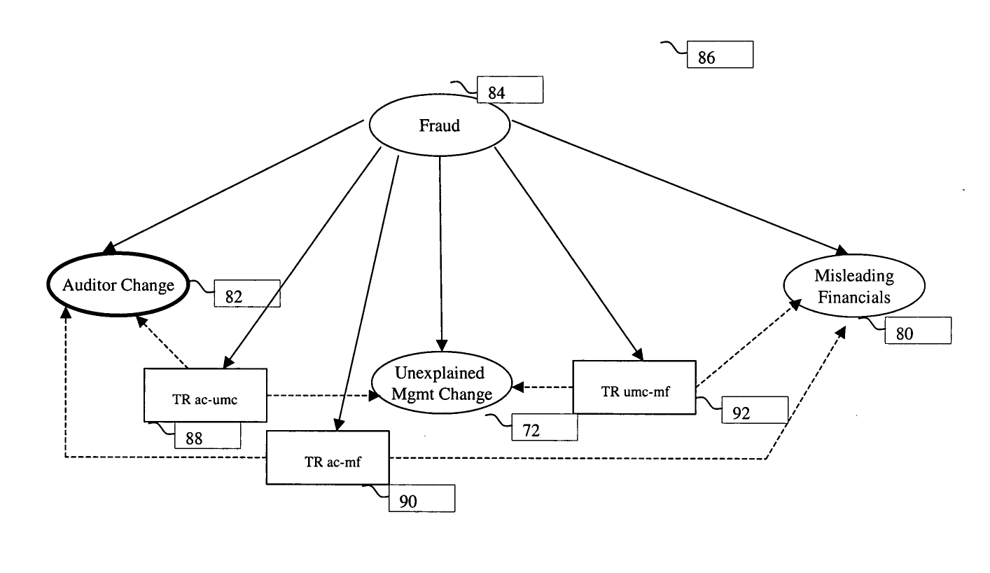

FIG. 5 is an exemplary interaction of one or more temporal relationships between the qualitative data and the quantitative data depicted in the heuristic of FIG. 4. FIG. 5 depicts the “fraud” node 84 and three contributing evidence nodes, “auditor change” 82, “unexplained management change” 72 and “misleading financials” 80, and their associated temporal relationships, TR_{ac}_{_{—}}_{umc} 88, TR_{ac}_{_{—}}_{mf} 90 and TR_{umc}_{_{—}}_{mf} 92. In this case, the inferred risk probability value for the “fraud” node P(fraud), is computed by a probability function of the following form:
P(Fraud)=f(AC′, UMC′, MF′, TR_{ac}_{_{—}}_{umc}, TR_{ac}_{_{—}}_{mf} TR_{umc}_{_{—}}_{mf}) (3)
wherein AC′=auditor change, UMC′=unexplained management change, MF′=misleading financials, each adjusted by their respective confidence weight, and TR_{ac}_{_{—}}_{umc}=the temporal relationship between auditor change and unexplained management change, TR_{ac}_{_{—}}_{mf}=the temporal relationship between auditor change and misleading financials, and TR_{umc}_{_{—}}_{mf}=the temporal relationship between unexplained management change and misleading financials.

Therefore, in accordance with the present embodiment, every data pair that contributes to a higher level node has a temporal relationship, and the number of temporal relationships that must be assessed when calculating the probability of an inferred node is equal to (n²—n)/2 where n is the number of evidence nodes contributing to the inferred node.

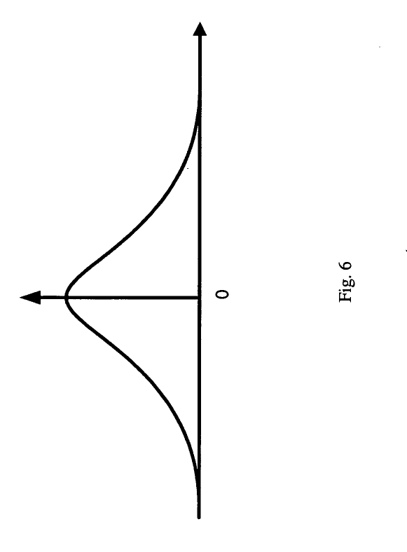

FIGS. 6-9 are illustrations of types of distributions to represent temporal relationships. In accordance with the present embodiment, three primary types of temporal relationships are used for risk assessment, “unordered proximity”, wherein event A occurs within n time units of event B, “preceding proximity”, wherein event A occurs not more than n time units prior to event B and “following proximity”, wherein event A occurs not more than n time units following event B. As used herein, A and B refer to qualitative events or quantitative metrics related to a business entity. Further, the number of time units may also be zero, that is, the events may occur simultaneously. In addition, the above reasoning may be extended to other types of temporal relationships, such as for example overlapping relationships. Proximity and order are important aspects of the temporal relationship between two events, because these temporal aspects can impact the belief that is contributed to the inferred risk based on the evidence data. Proximity is important because events that occur closer in time are generally more likely to be related than events that have a longer lag between them. For example, when inferring whether a significant management change has occurred, the observation that both CFO and CEO have changed within 3 months of each other implies a greater likelihood that a significant management change has occurred, than if the CEO and CFO changed with a 2 year lag between the events. Order may be important in that certain sequences of events may imply a risk that is not implied, or that is less likely, when the same events occur in a different order. For example, when inferring the existence of inventory problems, the observation that reported inventory is rising and that business entity has changed inventory valuation methods may lead to different levels of inferred risk depending on the order in which the events occur. Inventory rising before the valuation method is changed may indicate an inventory turnover problem that management is trying to mask by changing the valuation method, whereas inventory rising at the same time or after a valuation method change may simply be the result of the valuation method change, and not imply additional risk.

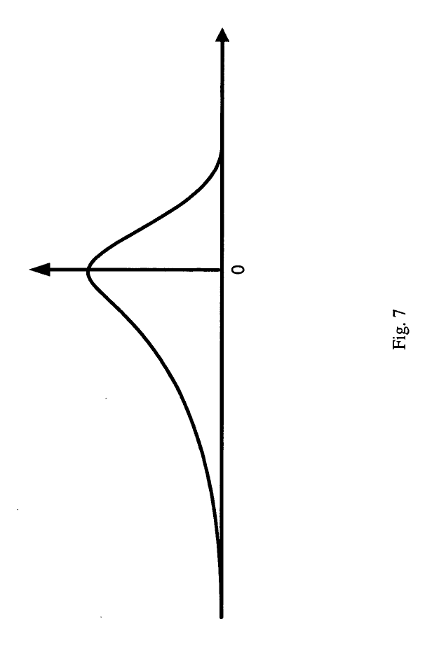

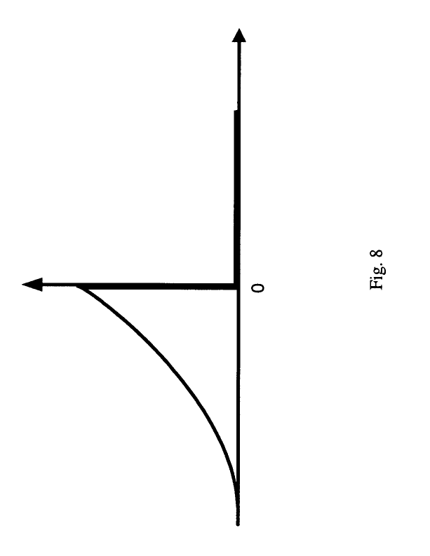

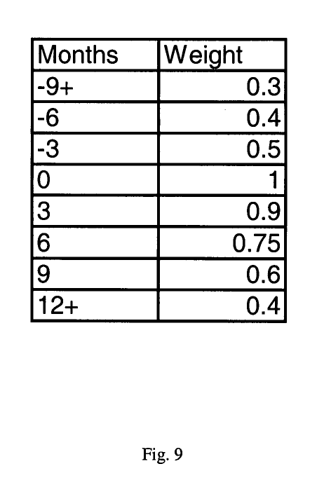

The distributions illustrated in FIGS. 6-8 provide the ability to represent temporal relationship weights based on both proximity and order. In these distributions, the truncated distribution below 0 represents the weights applied when Event A occurs before Event B (preceding order), and the truncation distribution above 0 represents the weights applied when Event A occurs after Event B (following order). FIG. 6 is an illustration of a normal distribution that represents an “unordered proximity” type of temporal relationship, in which a higher weight is assigned to events closer in proximity, but the weight at a given proximity is the same for either order of events. FIG. 7 is an illustration of a negatively skewed distribution that represents an “unordered proximity” type of relationship, wherein a higher weight is assigned to events closer in proximity and the preceding order carries more weight than the following order. FIG. 8 is an illustration of a distribution that represents a “preceding proximity” type of temporal relationship, wherein a higher weight is assigned to events closer in proximity and decreasing weight is assigned as Event A occurs farther in time before Event B, and no weight is applied if Event A occurs after Event B. Further, FIG. 9 is an illustration of a discrete table of exemplary weights for temporal ranges, wherein the preceding temporal relationship, in which event A occurs before event B, is assigned lower weights than the following relationship, in which event A occurs after event B, and the maximum weight is achieved when the events occur with a 0-month lag, i.e. at the same time.

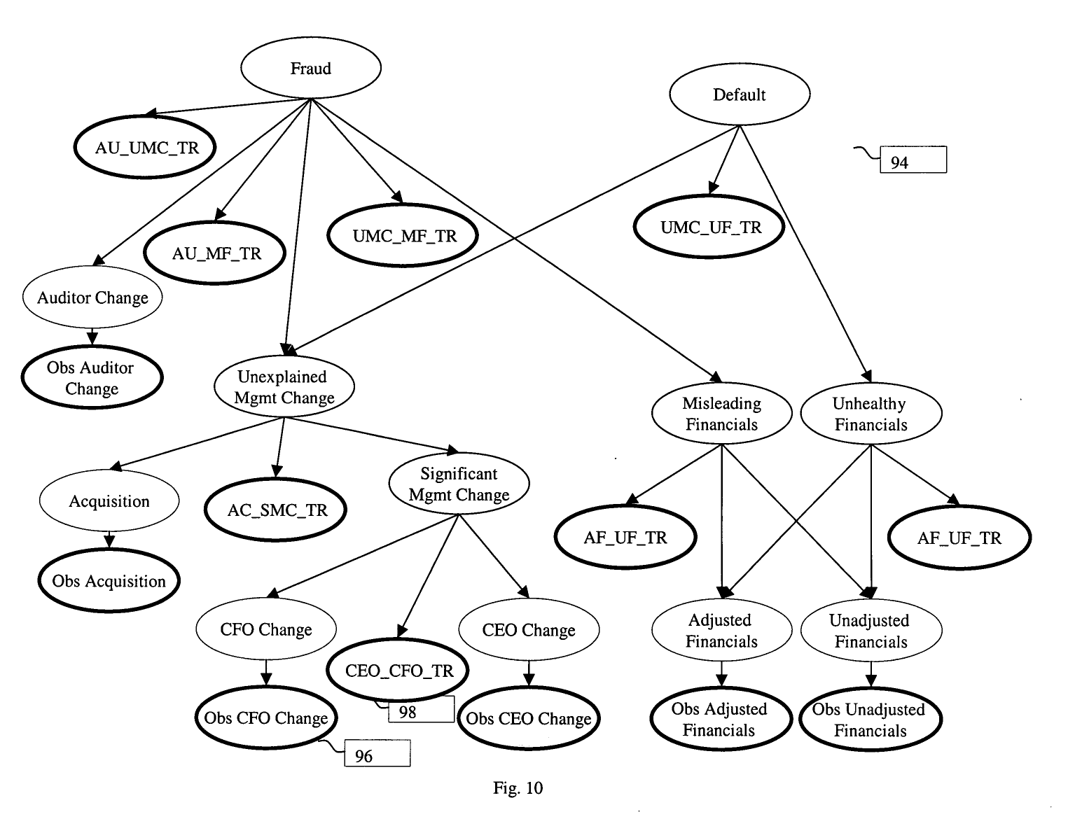

In an alternate embodiment of the invention, the risk assessment model may also be implemented using a Bayesian Belief Network (BBN) approach. FIG. 10 is an exemplary heuristic depicted using a Bayesian belief network 94. As will be appreciated by those skilled in the art, a BBN is a type of probabilistic network that defines various events, the dependencies between the events and the conditional probabilities involved in those dependencies. However, there are tradeoffs when implementing the risk assessment model using a BBN.

The confidence attributes and the temporal attributes are not part of the BBN network by default. Therefore, the data confidence weights and the temporal relationship weights need to be represented as separate nodes in the BBN. As shown in FIG. 10, additional nodes such as 96 and 98 are introduced into the BBN to capture the data confidence weights and the temporal relationship weights. As is apparent to those skilled in the art, the addition of extra nodes increases the visual complexity of the risk assessment model. Furthermore, the additional probability values for all the permutations of the states of the evidence nodes, and the temporal and confidence nodes that contribute to inferred nodes have to be explicitly defined, thereby increasing model complexity and cost of development, and decreasing the clarity of the data interrelationships.

As disclosed by the previous embodiment, implementing the risk assessment model using the probabilistic network as described in FIG. 4 enables the incorporation of the data confidence weights and the temporal relationship weights mathematically into the probability functions and does not require the presence of additional nodes to represent the data confidence weights and the temporal relationship weights. Furthermore, in the probabilistic network of FIG. 4, probability values for all permutations for all the evidence nodes, confidence and temporal states need not be explicitly specified as required by the BBN of FIG. 10.

In general, the risk assessment model may also be implemented using other reasoning frameworks that are known in the art, such as Dempster-Shafer theory, Markov models, etc., by suitably modifying the above frameworks to include data confidence and temporal relationships weights.

Further, in accordance with another embodiment of the invention, the fusion reasoning methodology described in the previous paragraphs may comprise extracting additional information from the quantitative data and the qualitative data to re-evaluate the inferred risk probability values and the business behavioral patterns. Once the additional information is extracted, the nodes are populated with this information and a confidence weight is re-calculated for these nodes. The above process can be repeated until a particular business behavioral pattern is predicted with a desired degree of confidence.

The previously described embodiments have many advantages, including the ability to perform complete and consistent analysis of business risk information and business behavioral patterns by incorporating both qualitative and quantitative data, their temporal relationship weights and their associated confidence weights into the risk analysis process. Furthermore, the invention reduces the cost of performing risk analysis by automating the fusion reasoning methodology and by using the knowledge gained by the fusion reasoning methodology to re-evaluate business risk information and business behavioral patterns. The lower cost and improved efficiency, in turn, enables a comprehensive analysis of a larger set of business entities than is currently possible using existing risk analysis techniques.

In addition, embodiments of the invention may be employed by commercial lending businesses to improve the ability to assess the risk associated with current and prospective customer accounts. Thus, a user may assign appropriate covenants and terms to maximize their gain from their accounts while minimizing their risk exposure. As will be appreciated by those skilled in the art, the ability to discriminate and select good prospective accounts, and to effectively monitor the risk of existing accounts is a significant contributor to the profitability of commercial lending businesses in general. The disclosed embodiments improve the capability to perform these processes uniformly and comprehensively and enable the selection and retention of a more profitable account portfolio.

Furthermore, embodiments of the invention may benefit business users for the purposes of account management. The documentation of the reasoning that produced the risk assessment provides an improved ability to defend changes to account terms, allowing a business user to effectively update accounts to reflect current levels of risk. In addition, the invention has applicability to various domains such as, for example, insurance, investing, asset leasing, and other domains involving commercial financial relationships.

The foregoing block diagrams and flowcharts of this invention show the functionality and operation of the system for detecting business behavioral patterns related to a business entity disclosed herein. In this regard, each block/component represents a module, segment, or portion of code, which comprises one or more executable instructions for implementing the specified logical function(s). It should also be noted that in some alternative implementations, the functions noted in the blocks may occur out of the order noted in the figures or, for example, may in fact be executed substantially concurrently or in the reverse order, depending upon the functionality involved. Also, one of ordinary skill in the art will recognize that additional blocks may be added. Furthermore, the functions may be implemented in programming languages such as Java and Matlab, however, other languages can be used, such as Perl, Visual Basic, C++, Mathematica and SAS.

The various embodiments described above comprise an ordered listing of executable instructions for implementing logical functions. The ordered listing can be embodied in any computer-readable medium for use by or in connection with a computer-based system that can retrieve the instructions and execute them. In the context of this application, the computer-readable medium can be any means that can contain, store, communicate, propagate, transmit or transport the instructions. The computer readable medium can be an electronic, magnetic, optical, electromagnetic, or infrared system, apparatus, or device. An illustrative, but non-exhaustive list of computer-readable media can include an electrical connection having one or more wires, a portable computer diskette, RAM, ROM, EPROM or Flash memory, an optical fiber, and a portable compact disc read-only memory (CDROM).

Note that the computer readable medium may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

It is apparent that there has been provided with this invention, a method and system for detecting business behavioral patterns related to a business entity. While the invention has been particularly shown and described in conjunction with a preferred embodiment thereof, it will be appreciated that variations and modifications can be effected by a person of ordinary skill in the art without departing from the scope of the invention.

1. A method for detecting business behavioral patterns related to a business entity comprising:
determining a model for business behavioral patterns in which the likelihood of a particular business behavioral pattern is associated with the occurrence of at least one qualitative event and at least one quantitative metric;
extracting a first data set representing the occurrence of the at least one qualitative event associated with the business entity from a first data source;
extracting a second data set representing the at least one quantitative metric associated with the business entity from a second data source;
determining a first confidence attribute and a first temporal attribute associated with the at least one qualitative event;
determining a second confidence attribute and a second temporal attribute associated with the at least one quantitative metric; and
evaluating the likelihood of the particular business behavior pattern by running the model based on the first data set, the second data set, the first confidence attribute, the first temporal attribute, the second confidence attribute and the second temporal attribute.

2. The method of claim 1, wherein the first data source comprises on-line news sources, commercial news sources, business trade and industry publications, news reports, footnotes to financial statements, and qualitative financial data learned in interviews and discussions with the business entity.

3. The method of claim 1, wherein the second data source comprises financial results and internal financial statements related to the business entity, stock exchange reports and quantitative risk scores.

4. The method of claim 1, wherein the particular business behavioral pattern comprises at least one of likelihood of fraud, financial credit or investment risk and good credit or investment prospect associated with the business entity.

5. The method of claim 1, wherein the first data set comprises verbal or narrative pieces of data representative of one or more business and financial occurrences associated with the business entity.

6. The method of claim 1, wherein the second data set comprises numerical data related to the financial health of the business entity.

7. The method of claim 1, wherein determining a first confidence attribute associated comprises determining a reliability value of the first data source.

8. The method of claim 1, wherein determining a second confidence attribute comprises determining a statistical confidence range of the quantitative metrics.

9. The method of claim 1, further comprising deriving one or more temporal relationships between the qualitative event and the quantitative metric from the first temporal attribute and the second temporal attribute.

10. The method of claim 1, wherein the model is a risk assessment model configured to infer business risk information and evaluate the likelihood of the business behavioral pattern related to the business entity from the at least one qualitative event, the at least one quantitative metric, the first temporal attribute, the second temporal attribute, the first confidence attribute and the second confidence attribute.

11. The method of claim 10, wherein the risk assessment model uses a fusion reasoning methodology to infer the business risk information and evaluate the likelihood of the business behavioral pattern.

12. The method of claim 10, wherein the risk assessment model further comprises extracting additional data from the first data source and the second data source to re-evaluate the business risk information and the business behavioral pattern.

13. The method of claim 1, wherein the model comprises a Bayesian belief network configured to infer business risk information and evaluate the likelihood of the business behavioral pattern related to the business entity from the at least one qualitative event, the at least one quantitative metric, the first temporal attribute, the second temporal attribute, the first confidence attribute and the second confidence attribute.

14. A method of detecting business behavioral patterns related to a business entity comprising:
formulating a risk assessment model related to the business entity;
expressing the risk assessment model as a probabilistic network with node elements, wherein the node elements comprise quantitative data and qualitative data;
determining a temporal attribute and a confidence attribute associated with the qualitative data and quantitative data and populating the node elements with the temporal attribute and confidence attribute;
inferring one or more risk probability values for one or more high level node elements comprising the probabilistic network based on the qualitative data and quantitative data in the node elements and the temporal attribute and confidence attribute; and
detecting the business behavioral patterns related to the business entity based on the one or more inferred risk probability values.

15. The method of claim 14, wherein the quantitative data and the qualitative data in the node elements in relation with the confidence attribute and temporal attribute serve as contributing sources of evidence for the high level node elements to infer the one or more risk probability values in the probabilistic network.

16. The method of claim 14, wherein the quantitative data comprise quantitative metrics and the qualitative data comprise qualitative events related to the business entity.

17. The method of claim 14, further comprising deriving one or more temporal relationships between the qualitative data and quantitative data from the temporal attribute.

18. The method of claim 14, wherein determining a confidence attribute associated with the quantitative data comprises determining a statistical confidence range of the quantitative data.

19. The method of claim 14, wherein determining a confidence attribute associated with the qualitative data comprises determining a reliability value of one or more data sources associated with the qualitative data.

20. The method of claim 14, wherein the risk assessment model comprises a fusion reasoning methodology to analyze the node elements comprising the quantitative data and the qualitative data in relation to the temporal attribute and the confidence attribute to infer the one or more risk probability values and the business behavioral patterns related to the business entity.

21. The method of claim 20, wherein the analysis comprises substantiating, explaining or repudiating the one or more inferred risk probability values related to the business entity from the quantitative data, the qualitative data, the temporal attribute and the confidence attribute.

22. The method of claim 20, wherein the fusion reasoning methodology further comprises extracting additional data from the quantitative data and the qualitative data to re-evaluate the one or more inferred risk probability values and the business behavioral patterns.

23. A system for detecting business behavioral patterns related to a business entity comprising:
a data extraction engine configured to extract:
a first data set representing the occurrence of at least one qualitative event associated with the business entity from a first data source; and
a second data set representing at least one quantitative metric associated with the business entity from a second data source; and
a data modeling engine configured to:
determine business behavioral patterns in which the likelihood of a particular business behavioral pattern is associated with the occurrence of the at least one qualitative event and the at least one quantitative metric;
determine a first confidence attribute and a first temporal attribute associated with the at least one qualitative event;
determine a second confidence attribute and a second temporal attribute associated with the at least one quantitative metric; and
evaluate the likelihood of the particular business behavior pattern based on the first data set, the second data set, the first confidence attribute, the first temporal attribute, the second confidence attribute and the second temporal attribute.

24. The system of claim 23, wherein the first data source comprises on-line news sources, commercial news sources, business trade and industry publications, news reports, footnotes to financial statements, and qualitative financial data learned in interviews and discussions with the business entity.

25. The system of claim 23, wherein the second data source comprises financial results and internal financial statements related to the business entity, stock exchange reports and quantitative risk scores.

26. The system of claim 23, wherein the data modeling engine is configured to determine the first confidence attribute based on a reliability value of the first data source.

27. The system of claim 23, wherein the data modeling engine is configured to determine the second confidence attribute based on a statistical confidence range of the quantitative metrics.

28. The system of claim 23, wherein the data modeling engine is further configured to derive one or more temporal relationships between the qualitative events and quantitative metrics from the first temporal attribute and the second temporal attribute.

29. The system of claim 23, wherein the data modeling engine comprises a risk assessment model configured to infer business risk information and evaluate the likelihood of the business behavioral pattern related to the business entity from the at least one qualitative event, the at least one quantitative metric, the first temporal attribute, the second temporal attribute, the first confidence attribute and the second confidence attribute.

30. The system of claim 29, wherein the risk assessment model further comprises extracting additional data from the first data source and the second data source to re-evaluate the business risk information and the business behavioral pattern.
